(19) United States
(12) Patent Application Publication
(10) Pub. No.: US 2012/0169700 A1
(43) Pub. Date: Jul. 5, 2012

(54) DISPLAY DEVICE, NONUNIFORMITY COMPENSATION METHOD AND COMPUTER PROGRAM

(75) Inventor: Hideto Mori, Tokyo (JP)

(73) Assignee: Sony Corporation, Tokyo (JP)

(21) Appl. No.: 13/394,438

(22) PCT Filed: Aug. 25, 2010
(86) PCT No.: PCT/JP2010/064374

§ 371 Date: Mar. 6, 2012

(30) Foreign Application Priority Data
Sep. 14, 2009 (JP) 2009-212073

(51) Int. Cl. G06F 3/038

(52) U.S. Cl. 345/211

(57) ABSTRACT

Provided is a display device including a display unit wherein a pixel having a pixel circuit for controlling current to be applied to emitting elements depending on the emitting elements that spontaneously emits depending on current volume, and a video signal, the scanning line that supplies the pixel with a selection signal which chooses a pixel to emit in a predetermined scanning period, a data line that supplies the pixel with the video signal are configured to be arranged in matrix, a first nonuniformity compensation unit that compensates emission unevenness to the video signal with linear characteristics, and a second nonuniformity compensation unit that compensates emission unevenness under a predetermined area to the video signal with gamma characteristics.

### TECHNICAL FIELD

The present invention relates to a display device, a nonuniformity compensation method and a computer program, more specifically, it relates to an active-matrix type display device in which the scanning line which chooses a pixel with a predetermined scanning period, the data line which gives the brightness information for driving a pixel, and a pixel circuit which makes a light emitting device emit light depending on a current amount are configured to be arranged in matrix.

### BACKGROUND ART

As a flat and thin display device, a liquid crystal display using the liquid crystal, a plasma display using plasma, are now in practical use.

A liquid crystal display is a display which has a back light and displays an image by passing or intercepting the light from the back light by changing the arrangement of liquid crystal elements by applying voltage. Further, a plasma display is a display device which becomes in the plasma state by applying voltage to the gas enclosed in a substrate, ultraviolet rays generated by the energy produced when returning from the plasma state to the original state serve as visible light while being emitted by a fluorescent substance, and displays an image.

On the other hand, in recent years, the development of a spontaneous light type display device using the organic electroluminescence (electroluminescence) element for which the element itself emits light when being applied voltage is advanced. An organic EL device changes from a ground state to an excitation state when receiving energy in electrolysis, and releases the energy of difference as a light when returning from an excitation state to a ground state. An organic electroluminescence display device is a display device which displays an image using the light which this organic EL device emits.

Since, unlike the liquid crystal display which needs a back light so that an element emits light itself, a spontaneous light type display device does not need a back light, it is possible to be thinly constituted compared with a liquid crystal display. Moreover, since the animation characteristic, a view angle characteristic, color reproduction nature, etc. are excellent compared with the liquid crystal display, the spontaneous light type display device using an organic EL device attracts attention as a next-generation flat-surface thin display.

Such a spontaneous light type display device has a process of exposing TFT (Thin Film Transistor; thin film transistor) which constitutes pixels by a laser beam, in manufacturing process. Therefore, this exposure process extends one laser beam to a flabellate form by an optical means, and is performing exposing treatment of TFT arranged to the perpendicular direction of the panel which displays an image by a flabellate laser beam. And exposing treatment is performed to TFT arranged at the whole panel by moving a panel horizontally.

However, a laser beam may not be uniformly irradiated to the panel since it has extended the laser beam to the flabellate form. Therefore, the manufactured panel is easy to produce muscle-like emission unevenness to a horizontal direction or a perpendicular direction. Emission unevenness may be locally produced besides a horizontal direction or a perpendicular direction. In addition, under the influence due to atmospheric temperature, humidity, and environment, manufacture dispersion resulting from a manufacturing installation, etc., the thickness and the characteristic of TFT, the resistance of various wiring, etc. show dispersion, and it looks like nonuniformity as a result. Therefore, the technology in which this emission unevenness is amended to display a uniform image is developed and proposed (for example, refer to patent documents 1).

### CITATION LIST

### Patent Literature

Patent literature 1: JP2005-316408A

### SUMMARY OF INVENTION

### Technical Problem

When performing nonuniformity compensation using a video signal and the input-output behavioral characteristics of a display device are not linear, in order to amend nonuniformity appropriately in each tone, it must have compensation data of two or more surfaces. Although technology which absorbs only the difference in the emission point of each pixel with a single compensation surface is also published like invention indicated in the patent documents 1, to apply this technology, it is necessary to have the same gamma characteristic in all the pixels. However, since dispersion in the gamma characteristic exists for every pixel by various factors in reality, it is very difficult to amend nonuniformity with the application of this technology.

Further, in the spontaneous light type display device using a common organic EL device, the nonuniformity in the field by the side of low tone (super-low tone side) is not a problem when being used. However, in the display for professionals and semiprofessionals, such as a studio monitor, a master monitor, and a monitor for photographs for checking photographs, even the nonuniformity by the side of super-low tone may cause a problem in its quality.

As a method of reducing compensation data and compensating nonuniformity efficiently, there is a method provided in which input and output make linear space on signal processing to compensate using few compensation data in the linear space. However, as far as making linear space by this method, there is a high possibility that linear space will collapse in the super-low tone. This originates in the bit error at the digitization, and if bit width is narrow, linear space will more remarkably collapse. Although what is necessary is just to have expanded the bit width of linear space in order to compensate collapse of linear space, if bit width become larger, it leads to increase of the calculation capacity in IC (integrated circuit) and to increase circuit structure as a result, there was a problem of causing increase of power consumption and a circuit area.

Then, the present invention is made in light of the above-mentioned problems, and the purpose of the present invention is to provide a display device, a nonuniformity compensation method, and a computer program, which are new and innovative, which are capable of compensating nonuniformity in a low tone side area effectively by setting another nonuniformity side other than the linear space as well as compensating nonuniformity in a linear space to carry out nonuniformity compensation in the low tone side so as to prevent power consumption and a circuit area from being increased.

### Solution to Problem

According to an embodiment of the present invention in order to achieve the above-mentioned object, there is provided a doing apparatus including a display unit wherein a pixel having a pixel circuit for controlling current to be applied to emitting elements depending on the emitting elements that spontaneously emits depending on current volume, and a video signal, the scanning line that supplies the pixel with a selection signal which chooses a pixel to emit in a predetermined scanning period, a data line that supplies the pixel with the video signal are configured to be arranged in matrix, a first nonuniformity compensation unit that compensates emission unevenness to the video signal with linear characteristics, and a second nonuniformity compensation unit that compensates emission unevenness under a predetermined area to the video signal with gamma characteristics.

Compensation of emission unevenness under a predetermined area may be performed by the second nonuniformity compensation unit after compensation of emission unevenness by the first nonuniformity compensation unit.

Compensation of emission unevenness over a predetermined area may be performed by the first nonuniformity compensation unit after compensation of emission unevenness by the second nonuniformity compensation unit under a predetermined area.

The display device may further include a controller that transmits threshold specifying the predetermined area to the first nonuniformity compensation unit and the second nonuniformity compensation unit.

According to another aspect of the present invention in order to achieve the above-mentioned object, there is provided a compensation nonuniformity method including the steps of a first nonuniformity compensation that compensates emission unevenness displayed on a display unit in which a pixel having a pixel circuit for controlling current to be applied to emitting elements depending on the emitting elements that spontaneously emits depending on current volume, and a video signal, the scanning line that supplies the pixel with a selection signal which chooses a pixel to emit in a predetermined scanning period, a data line that supplies the pixel with the video signal are configured to be arranged in matrix, to the video signal with linear characteristics, and a second nonuniformity compensation unit that compensates emission unevenness under a predetermined area to the video signal with gamma characteristics.

Compensation of emission unevenness under a predetermined area may be performed by the second nonuniformity compensation step after compensation of emission unevenness by the first nonuniformity compensation step.

Compensation of emission unevenness over a predetermined area may be performed by the first nonuniformity compensation step after compensation of emission unevenness by the second nonuniformity compensation step under a predetermined area.

A nonuniformity compensation method may include the step of a threshold transmitting that transmits threshold specifying the predetermined area when compensating in the first nonuniformity compensation step and the second nonuniformity compensation step.

According to another aspect of the present invention in order to achieve the above-mentioned object, there is provided a computer program for causing a computer to execute the steps of a first nonuniformity compensation that compensates emission unevenness displayed on a display unit in which a pixel having a pixel circuit for controlling current to be applied to emitting elements depending on the emitting elements that spontaneously emits depending on current volume, and a video signal, the scanning line that supplies the pixel with a selection signal which chooses a pixel to emit in a predetermined scanning period, a data line that supplies the pixel with the video signal are configured to be arranged in matrix, to the video signal with linear characteristics, and a second nonuniformity compensation unit that compensates emission unevenness under a predetermined area to the video signal with gamma characteristics.

### Advantageous Effects of Invention

According to the present invention, a display device, a nonuniformity compensation method, and a computer program, which are new and innovative, which are capable of compensating nonuniformity in a low tone side area effectively by setting another nonuniformity side other than the linear space as well as compensating nonuniformity in a linear space to carry out nonuniformity compensation in the low tone side so as to prevent power consumption and a circuit area from being increased.

### BRIEF DESCRIPTION OF DRAWINGS

FIG. 1 is explanatory view explaining a configuration of a display device 100 according to a first embodiment of the present invention.

FIG. 2 is an explanatory view which illustrates in a graph a change of the characteristic of the signal which flows through the display device 100 according to the first embodiment of the present invention.

FIG. 3 is an explanatory view explaining a configuration of the nonuniformity compensation unit 130 according to the first embodiment of the present invention.

FIG. 4 is an explanatory view showing the conventional method of compensation nonuniformity.

FIG. 5 is an explanatory view showing the conventional method of compensation nonuniformity.

FIG. 6 is an explanatory view showing the method of compensation nonuniformity by the display device 100 according to the first embodiment of the present invention.

FIG. 7 is an explanatory view explaining a configuration of the display device 100 according to a second embodiment of the present invention.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Explanation shall be given in following order.

### <1. First Embodiment>

[1-1. Configuration of display device]

[1-2 Characteristic of the signal which flows through the display device]

[1-3 Configuration of nonuniformity compensation unit]

### <2. Second Embodiment>

### <3. Conclusion>

### 1. First Embodiment

[1-1. Configuration of Display Device]

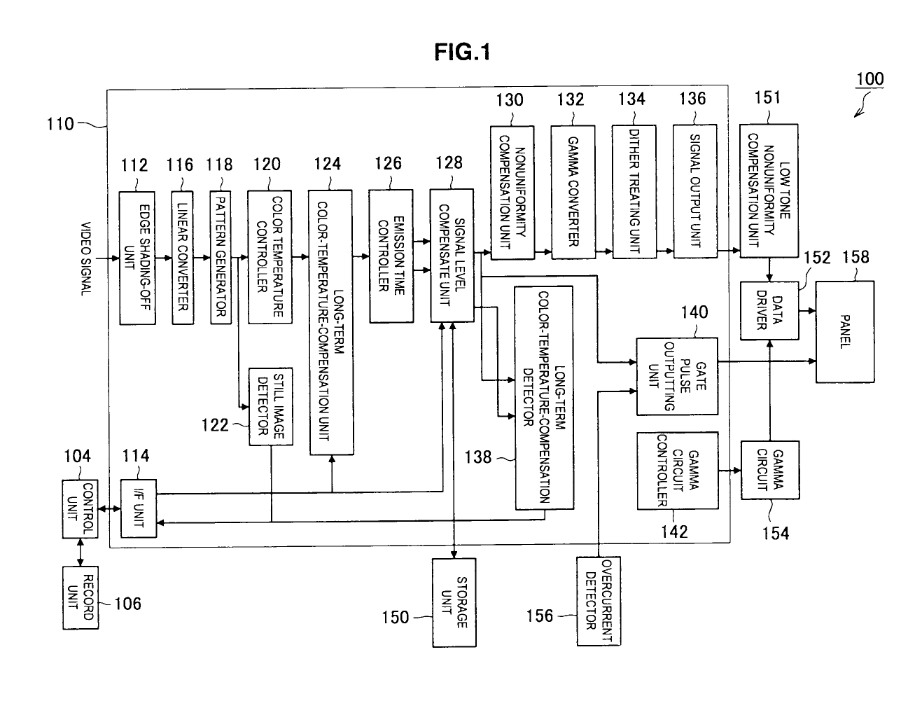

First, the configuration of the display device according to the first embodiment of the present invention is explained. FIG. 1 is an explanatory view explaining the configuration of the display device 100 according to a 1st embodiment of the present invention. Hereafter, the configuration of the display device 100 applied to the first embodiment of the present invention using FIG. 1 is explained.

As shown in FIG. 1, the display device 100 according to an embodiment of the present invention is configured to include a control unit 104, a record unit 106, a signal-processing integrated circuit 110, a storage unit 150, a low tone nonuniformity compensation unit 151, a data driver 152, a gamma circuit 154, an overcurrent detector 156, and a panel 158.

The signal-processing integrated circuit 110 is configured to include an edge shading-off unit 112, an I/F unit 114, a linear converter 116, a pattern generator 118, a color temperature controller 120, a still image detector 122, a long-term color-temperature-compensation unit 124, and an emission time controller 126, a signal level compensation unit 128, a nonuniformity compensation unit 130, a gamma converter 132, a dither treating unit 134, a signal output unit 136, a long-term color-temperature-compensation detector 138, a gate pulse outputting unit 140, and the gamma circuit controller 142.

When receiving a supply of a video signal, the display device 100 will analyses the video signal and turns on the pixel arranged inside the panel 158 described later according to the analyzed contents so as to display the video through the panel 158.

The control unit 104 controls the signal-processing integrated circuit 110, and delivers and receives a signal between the I/F units 114. The control unit 104 performs various signal processing to the signal received from the I/F unit 114. Signal processing performed by the control unit 104 has the calculation of a gain used for adjustment of the luminosity of the image displayed, for example on the panel 158.

The record unit 106 is to store information for controlling the signal-processing integrated circuit 110 in the control unit 104. It is preferred to use a memory which is able to store without deleting information even in a state when the display device 100 is turned off as the record unit 106. It is desirable to use EEPROM (Electronically Erasable and Programmable Read Only Memory) which is able to rewrite the contents electrically, for example as a memory adopted as the record unit 106. EEPROM is a nonvolatile memory which is able to write and delete data when the EEPROM is mounted in a substrate.

The signal-processing integrated circuit 110 inputs a video signal, and performs signal processing to the inputted video signal. In this embodiment, the video signal inputted into the signal-processing integrated circuit 110 is a digital signal, and signal width is 10 bits. Signal processing to the inputted video signal is performed in each unit inside the signal-processing integrated circuit 110.

The edge shading-off unit 112 performs signal processing for obscuring edge to the inputted video signal. Specifically, in order to prevent the burn-in phenomenon of image to the panel 158, the edge shading-off unit 112 obscures edge by shifting the image intentionally.

The linear converter 116 performs signal processing which converts the video signal whose an output to an input has the gamma characteristic so that it may have a linear characteristic from the gamma characteristic. By performing signal processing so that the output to the input may have a linear characteristic by the linear converter 116, various processing to the image displayed by the panel 158 become easy. By signal processing in the linear converter 116, the signal width of a video signal spreads in 14 bits from 10 bits. If a video signal is converted so that it may have a linear characteristic by the linear converter 116, it will convert so that it may have the gamma characteristic in the gamma converter 132 mentioned later.

The pattern generator 118 generates the test pattern used by image processing inside the display device 100. As a test pattern used by the image processing inside the display device 100, there is a test pattern used for the display inspection of the panel 158, for example.

The color temperature controller 120 adjusts the color temperature of a image, and adjusts the color displayed by the panel 158 of the display device 100. Although not illustrated to FIG. 1, the display device 100 is equipped with the color temperature adjustment device for adjusting a color temperature, and the color temperature of the image displayed on a screen is possible to be manually adjusted when a user operates a color temperature adjustment device.

The long-term color-temperature-compensation unit 124 compensates aging due to differences of luminosity and time characteristics (LT characteristics) in each color of R (red), G (green), and B (blue) of an organic EL device. The organic EL device has difference characteristics for each color of R, G, and B, therefore color balance is to be lost as the emission time elapses. It is to compensate its color balance.

The emission time controller 126 computes a duty ratio of pulse at the time of displaying a video on the panel 158, and controls the emission time of an organic EL device. The display device 100 passes current to the organic EL device inside of the panel 158 when the pulse is in a state of HI, so as to make the organic EL device emit light to display the image.

The signal level compensate unit 128 adjusts the luminosity of the image displayed on the panel 158 by compensating the signal level of a video signal in order to prevent the burn-in phenomenon of image. The burn-in phenomenon of image is a deterioration phenomenon of the emitting properties which the luminescence frequency of a specific pixel is higher in comparison with other pixels, and the deteriorated pixels causes the fall of luminosity comparing with other pixels which have not deteriorated, and luminance difference becomes large with the portion in the circumference that is not deteriorated. Due to this difference of luminosity, it looks as if characters have been burned-in on the screen.

The signal level compensate unit 128 computes the amount of luminescence of each pixel or pixel group using the video signal and the duty ratio of pulse calculated in the emission time controller 126, calculates a gain for reducing the luminescence as needed based on the computed amount of luminescence, and multiplies the video signal by the computed gain.

The long-term color-temperature-compensation detector 138 detects the information for compensating in the long-term color-temperature-compensation unit 124. The information detected by the long-term color-temperature-compensation detector 138 is sent to the control unit 104 through the I/F unit 114, and is recorded on the record unit 106 via the control unit 104.

The nonuniformity compensation unit 130 compensates the nonuniformity of the image and video displayed on the panel 158. In the nonuniformity compensation unit 130, the emission unevenness locally produced on the lateral stripe, vertical stripe and screen of the panel 158 is compensated on the basis of the level and coordinate position of an input signal.

The gamma converter 132 performs signal processing to convert the video signal converted to have linear characteristics in the linear converter 116 so that it may have the gamma characteristic. The signal processing performed in the gamma converter 132 is signal processing cancels the gamma characteristics that the panel 158 has and converts it into a signal having linear characteristics so that the organic EL device inside the panel 158 may emit light according to the current of the signal. By performing the signal processing in the gamma converter 132, signal width changes from 14 bits to 12 bits.

The dither treating unit 134 performs dithering to the signal converted in the gamma converter 132. Dithering is displaying combining the color which can be displayed, in order to express neutral colors in an environment with few numbers of colors to be used. By dithering in the dither treating unit 134, it is possible to realize the color which originally cannot be displayed on a panel can be made seemingly. Signal width changes from 12 bits to 10 bits due to the dithering in the dither treating unit 134

The signal output unit 136 outputs the signal to the data driver 152 after dithering was performed by the dither treating unit 134. The signal passed to the data driver 152 from the signal output unit 136 is a signal with the information on the amount of luminescence of each color of R, G, and B, and the signal with the information on emission time is outputted in form of pulse from the gate pulse outputting unit 140.

The gate pulse outputting part 140 outputs the pulse which controls the emission time of the panel 158. The pulse outputted from the gate pulse outputting part 140 is a pulse based on the duty ratio computed by the emission time controller 126. The emission time of each pixel in the panel 158 is determined based on the pulse from the gate pulse outputting part 140.

The gamma circuit controller 142 gives a preset value to the gamma circuit 154. The preset value which the gamma circuit controller 142 gives is the reference voltage for giving the ladder resistance of the D/A converter contained inside of the data driver 152.

The storage unit 150 matches and stores the information on the pixel or pixel group which emit lights exceeding predetermined luminosity in correlation with the information on the amount exceeding, which are necessary when compensating luminosity in the signal level compensate unit 128. Different from the record unit 106, as the storage unit 150, it may use a memory that the contents are eliminated when power supply turns off, and as such a memory, for example, it is expected to use SDRAM (Synchronous Dynamic Random Access Memory).

The low tone nonuniformity compensation unit 151 performs the nonuniformity compensation process limited to the area of the low tone side of the video signal with the gamma characteristic. Although the nonuniformity compensation process in the low tone nonuniformity compensation unit 151 performs basically the processing same with the nonuniformity compensation process in the nonuniformity compensation unit 130, it differs from the nonuniformity compensation process in the nonuniformity compensation unit 130 in that the nonuniformity compensation process in the low tone nonuniformity compensation unit 15 is carried out limited to the field area of the low tone side of the video signal.

The overcurrent detector 156 detects the over-current, when an over-current arises due to the short circuit of a substrate, etc., and it notifies it to the gate pulse outputting unit 140. The over-current generation information from the overcurrent detector 156 can prevent applying the over-current to the panel 158 when an over-current arises.

The data driver 152 performs signal processing to the signal received from the signal output part 136, and outputs the signal for displaying video by the panel 158 to the panel 158. A D/A converter is contained in the data driver, although not illustrated, and the D/A converter converts a digital signal into an analog signal to output it.

The gamma circuit 154 gives reference voltage to the ladder resistance of the D/A converter contained in inside of the data driver 152. The reference voltage for giving ladder resistance is generated by the gamma circuit controller 142 as mentioned above.

The panel 158 inputs the output pulse from the output signal from the data driver 152 and the output pulse from the gate pulse output unit 140, and displays an moving image or still image by making the organic EL device which is an example of a spontaneous optical element emit light. The form of a surface where the panel 158 displays an image is a flat surface. An organic EL device is a spontaneous light type element which will emit light if voltage is applied, and the light quantity is proportional to voltage. Therefore, the IL characteristic (current-light quantity characteristic) of an organic EL device also has proportionality.

The panel 158 is configured to arrange, although not illustrated, the scanning line which chooses a pixel in a predetermined scanning period, and a pixel circuit that controls current amount based on the luminescence information and makes the organic EL device which is an emitting element emit depending on the current amount in matrix. Because the scanning line, the data line and the pixel circuit are configured in such a manner, the display device 100 can display a video according to the video signal.

In the above, the configuration of the display device 100 according to one embodiment of the present invention using FIG. 1 has been explained. The display device 100 according to the embodiment of the present invention shown in FIG. 1 inputs the converted video signal into the pattern generator 118, after converting the video signal so that it may have a linear characteristic by the linear converter 116, but it may replace the pattern generator 118 with the linear converter 116.

[1-2 Characteristic of Signal which Flows Through Display Device]

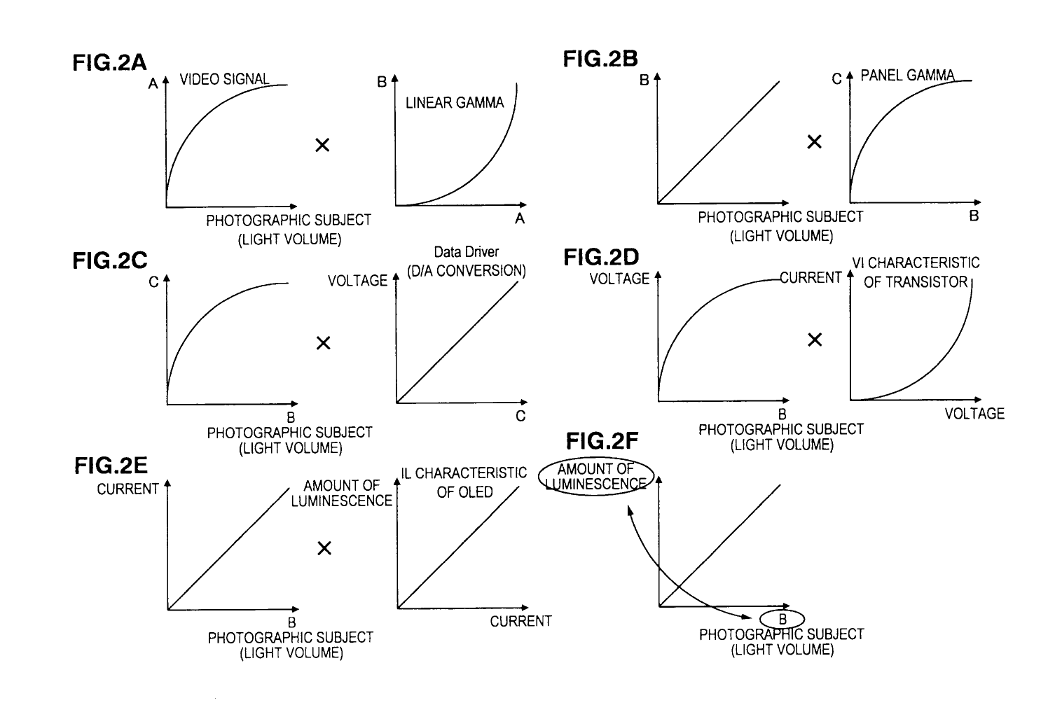

Next, a change of the characteristic of the signal which flows through the display device 100 according to an embodiment of the present invention will be explained. FIG. 2 is an explanatory view which illustrates in a graph a change of the characteristic of the signal which flows through the display device 100 according to the embodiment of the present invention. Each graph of FIG. 2 shows a horizontal axis as an input while the vertical axis as an output.

(a) of FIG. 2 shows that an output A to the light volume of a photographic subject multiplies a reverse gamma curve (linear gamma) by the linear converter 116 to the video signal which has the gamma characteristic when a photographic subject is inputted, and converts the video signal so that the output to the light volume of the photographic subject may have a linear characteristic.

(b) of FIG. 2 shows that by multiplying a gamma curve in the gamma converter 132 to the video signal converted so that the characteristic of the output B to the input of the light volume of the photographic subject may have a linear characteristic, the video signal is converted so that the output to the input of the light volume of the photographic subject may have the gamma characteristic.

(c) of FIG. 2 shows that D/A conversion in the data driver 152 was performed to the video signal converted so that the characteristic of the output C to the input of the light volume of a photographic subject might have the gamma characteristic. In D/A conversion, the relation between the input and the output has a linear characteristic. Therefore, by performing D/A conversion by the data driver 152, the output voltage has the gamma characteristic when the light volume of a photographic subject is inputted.

(d) of FIG. 2 shows that both gamma characteristics is negated when the video signal to which the D/A conversion was performed is inputted into the transistor contained in the panel 158. The VI characteristic of the transistor is the gamma characteristic having a curve contrary to the gamma characteristic of output voltage to the input of the light volume of a photographic subject. Therefore, if the light volume of a photographic subject is inputted, it is convertible again so that output current may have a linear characteristic.

(e) of FIG. 2 shows that by inputting the signal in which the output current has the linear characteristic as the light volume of the photographic subject into the panel 158, the signal having the linear characteristic is multiplied by the IL characteristics of an organic EL device having a linear characteristic as mentioned above.

As a result, as shown in (f) of FIG. 2, since the light quantity of a panel (OLED; Organic Light Emitting Diode) has a linear characteristic, if the light volume of a photographic subject is inputted, it becomes possible to perform signal processing between the linear converter 116 and the gamma converter 132 in the signal-processing integrated circuit 110 shown in FIG. 1 as a linear field by converting a video signal so that a reverse gamma curve may be multiplied by the linear converter 116 to have a linear characteristic.

In the above, the change of the signal characteristic of the signal which flows through the display device 100 according to one embodiment of the present invention has been explained.

[1-3 Configuration of Nonuniformity Compensation Unit]

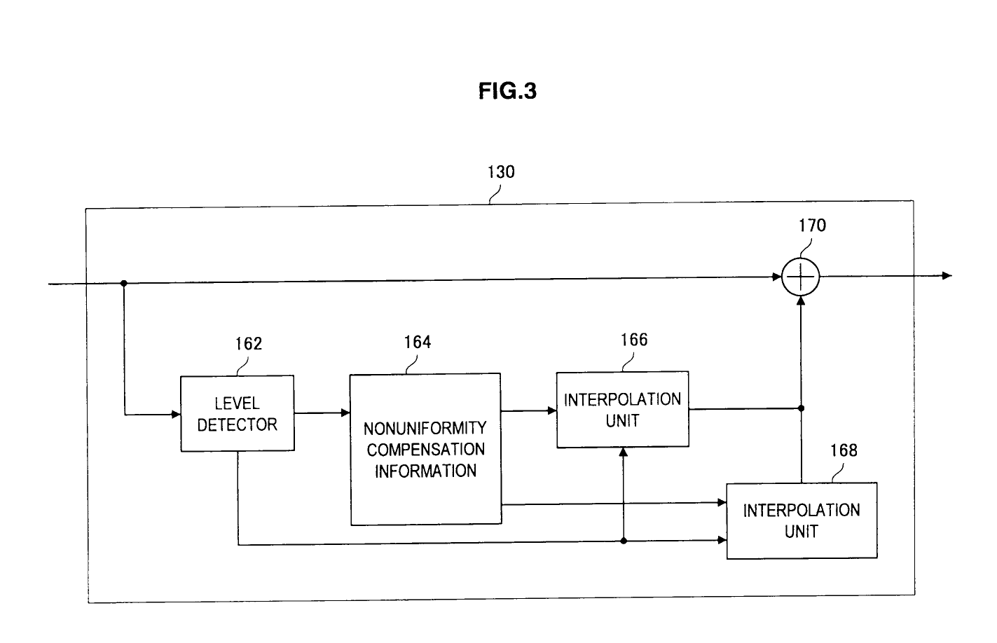

Then, the configuration of the nonuniformity compensation unit 130 according to one embodiment of the present invention is explained. FIG. 3 is an explanatory view explaining the configuration of the nonuniformity compensation unit 130 according to one embodiment of the present invention.

As shown in FIG. 3, the nonuniformity compensation unit 130 according to one embodiment of the present invention is constituted including a level detector 162, a nonuniformity compensation information storage unit 164, interpolation units 166 and 168, and an adding machine 170.

The level detector 162 detects the voltage (level) of a video signal. If the level of a video signal is detected by the level detector 162, the detected level will be sent to the nonuniformity compensation information storage unit 164.

Information for the nonuniformity compensation information storage unit 164 to compensate the emission unevenness of the image displayed on the panel 158 is stored. It is preferred to use the memory which can be stored without information disappearing in the state where the display device 100 is turned off as well as the record part 106 as a nonuniformity compensation information storage unit. It is desirable to use EEPROM which can rewrite the contents electrically, for example as the nonuniformity compensation information storage unit 164 as a memory to adopt. Here, the information for compensating the emission unevenness of the image displayed on the panel 158 is explained.

Where the video signal which has a uniform value to the panel 158 is supplied, when the display surface of the image of the panel 158 is imaged by the imaging means of a video camera etc. and there is no emission unevenness in the panel 158, the signal of a uniform value can be acquired from the imaging means. However, when the panel 158 has emission unevenness, the signal with which a value changes according to emission unevenness will be acquired from the imaging means.

Then, in order to detect whether the panel 158 has produced emission unevenness, a video signal which emits light by two or more predetermined luminosity in the panel 158 is supplied to the panel 158. Such a video signal is generated, for example in the pattern generator 118, may be supplied to the panel 158, may be generated in the exterior of the display device 100, and may be supplied to the display device 100. Here, in the display device 100, since it has a relation with linear (linearity) the voltage impressed in each pixel of the panel 158 and the luminosity in each pixel of the panel 158, the luminosity in the panel 158 will change in proportion to the signal level (voltage) of a video signal.

If the panel 158 receives the input of a video signal which emits light by predetermined luminosity according to the video signal, the panel 158 will emit light. A signal level is acquired from the image of the display surface of the panel 158 which imaged the display surface of the luminous panel 158 by the imaging means, and was imaged by the imaging means. In inputting the acquired signal level into an external dedicated purpose computer (not shown), the compensation data of the emission unevenness in the luminosity is obtained.

That is, the compensation data of the emission unevenness at the luminosity is compensation data for compensating signal level of the video signal for a part having the emission unevenness when the image which the panel 158 displays by the luminosity has emission unevenness, so that the emission unevenness in the panel 158 is lost. And if such compensation data is stored in the nonuniformity compensation information storage unit 164, it is possible to reduce emission unevenness peculiar to the panel 158 to display an image by compensating the signal level of a video signal based on the compensation data stored.

As mentioned above, the panel 158 has the process of exposing TFT which constitutes a pixel by a laser beam and is easy to produce muscle-like emission unevenness to the horizontal direction and perpendicular direction of the panel 158 due to the exposure process by the laser beam. Emission unevenness may be locally produced besides the horizontal direction and perpendicular direction of the panel 158.

Therefore, the compensation data of the emission unevenness includes compensation data for compensating emission unevenness which is produced to the horizontal direction and perpendicular direction of the panel 158, and compensation data for compensating the emission unevenness which the panel 158 produces locally. The display device 100 in this embodiment compensates combining compensation of the emission unevenness produced to a horizontal direction or a perpendicular direction (hereinafter referred to as “compensation in horizontal and perpendicular direction”), and the compensation of the emission unevenness produced locally (it is also called the following “spot compensation”).

The interpolation units 166 and 168 generate a compensation signal for interpolation to compensate a video signal. The emission unevenness in the panel 158 is compensated by compensating a video signal using the compensation signal generated by the interpolation units 166 and 168.

Here, the difference between the interpolation unit 166 and the interpolation unit 168 is that the interpolation unit 166 generates a compensation signal when the interpolation unit 166 compensates emission unevenness by compensation in horizontal and perpendicular direction, while the interpolation unit 168 generates a compensation signal when to compensate emission unevenness by spot compensation. It may specify whether to compensate the emission unevenness using either the compensation in horizontal and perpendicular direction or the spot compensation, or to compensate the emission unevenness using both of the compensation in horizontal and perpendicular direction or the spot compensation, when the compensation information is stored in the nonuniformity compensation information storage unit 164 depending on a state of the emission unevenness occurred in the panel 158.

The adding machine 170 adds the compensation signal generated in the interpolation units 166 and 168, and the video signal inputted into the nonuniformity compensation unit 130. The emission unevenness in the panel 158 can be amended by the compensation signal generated in the interpolation units 166 and 168 and the video signal inputted into the nonuniformity compensation unit 130 being added.

In the above, the configuration of the nonuniformity compensation unit 130 according to an embodiment of the present invention has been explained using FIG. 3. As mentioned above, the low tone nonuniformity compensation unit 151 also has the same configuration as the nonuniformity compensation unit 130 shown in FIG. 3. In this embodiment, at the low tone side, it considers that it has the characteristic whose gamma characteristic of a signal is almost linear, and the low tone nonuniformity compensation unit 151 has only one surface of compensation surfaces in the low tone side, and performs nonuniformity compensation to the field by the side of low tone. Therefore, in the field of the low tone side, the low tone nonuniformity compensation unit 151 which has configuration like FIG. 3 can amend the emission unevenness in the field of the low tone side in the panel 158.

When performing nonuniformity compensation to the field of the low tone side, in order not to affect the nonuniformity compensation to the signal in the linear field which the nonuniformity compensation unit 130 performed, the low tone nonuniformity compensation unit 151 may perform nonuniformity compensation only to the field below a specific input value.

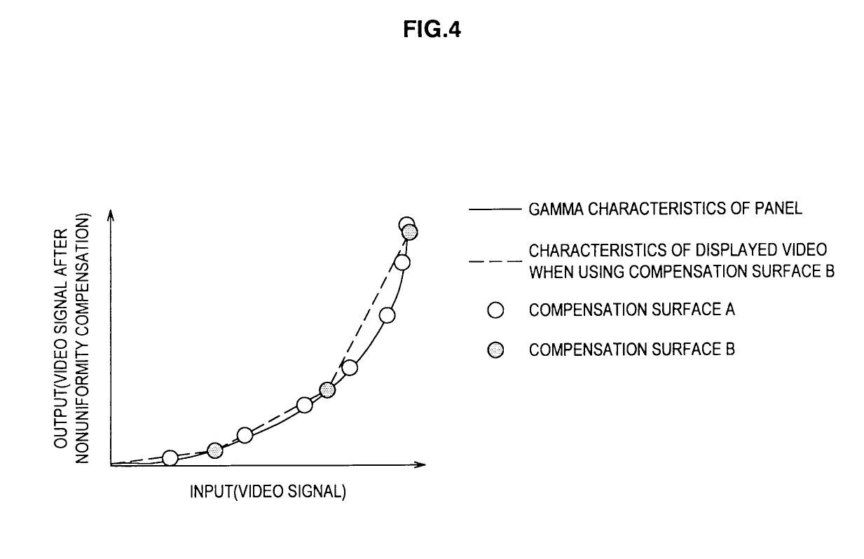

The conventional nonuniformity compensation method prepared compensation surfaces according to the gamma characteristic of a panel, as shown, for example in FIG. 4. Like the “compensation surface A” of FIG. 4, if many compensation surfaces are prepared according to the gamma characteristic of a panel, the nonuniformity compensation can be realized suitable to the gamma characteristic of the panel. However, since many compensation surfaces must be prepared, processing becomes complicated, and the capacity for holding the compensation data is necessary. It depends on the holding method of compensation data, however, in order to compensate nonuniformity, about 7 or 8 of the compensation surfaces are necessary, which requires the compensation data requiring a storage capacity of 500 megabyte or more. However, if compensation surfaces are reduced like the “compensation surfaces B” of FIG. 4, processing is simplified compared with the case of the compensation surfaces A, on the other hand, the error from the gamma characteristic and the gamma characteristic a display device will be outstanding.

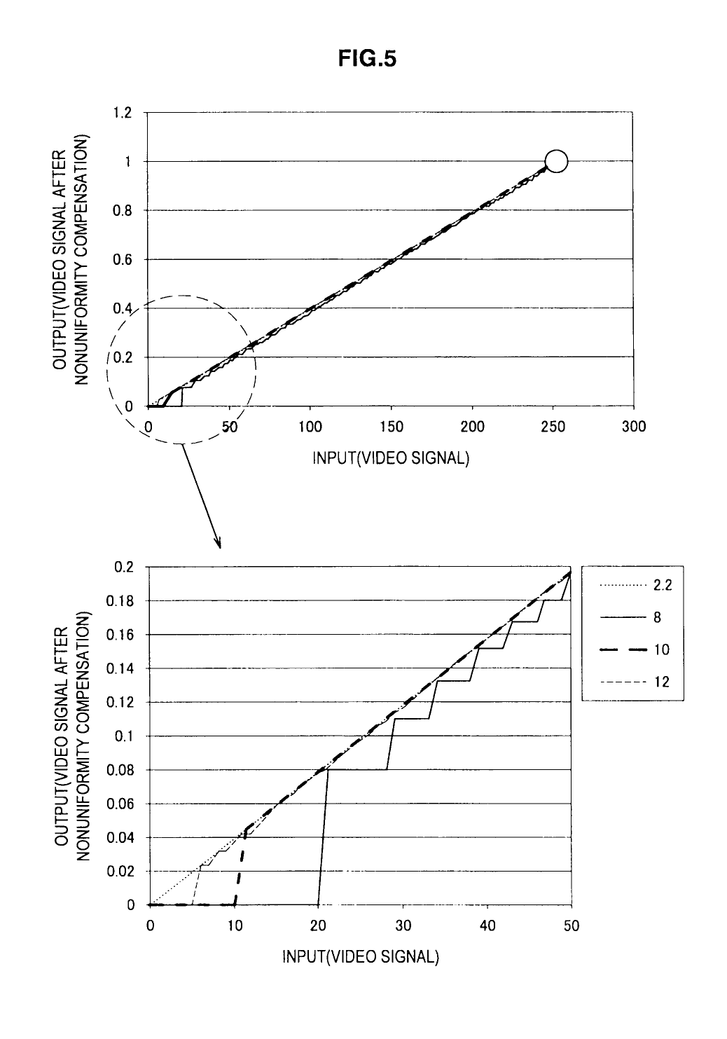

The conventional nonuniformity compensation method performed, as shown in FIG. 5, for example, nonuniformity compensation after converting the video signal so that it might have a linear characteristic. If this nonuniformity compensation method is used, only one compensation surface is enough, nonuniformity compensation process will be simplified and the capacity for holding compensation data will be small. However, on the problem resulting from the bit error produced in the case of digitization, there was a problem that the error from a linear characteristic increased in the low tone side and nonuniformity could not be compensated correctly. If bit width is expanded (if it extends to about 16 to 18 bits), it is possible to suppress collapse of linear space in the low tone side. On the contrary, however, since expanding bit width increased the bus width of a circuit and computational complexity, there was a problem of causing increase of circuit structure and as a result causing the increase in power consumption and a circuit area.

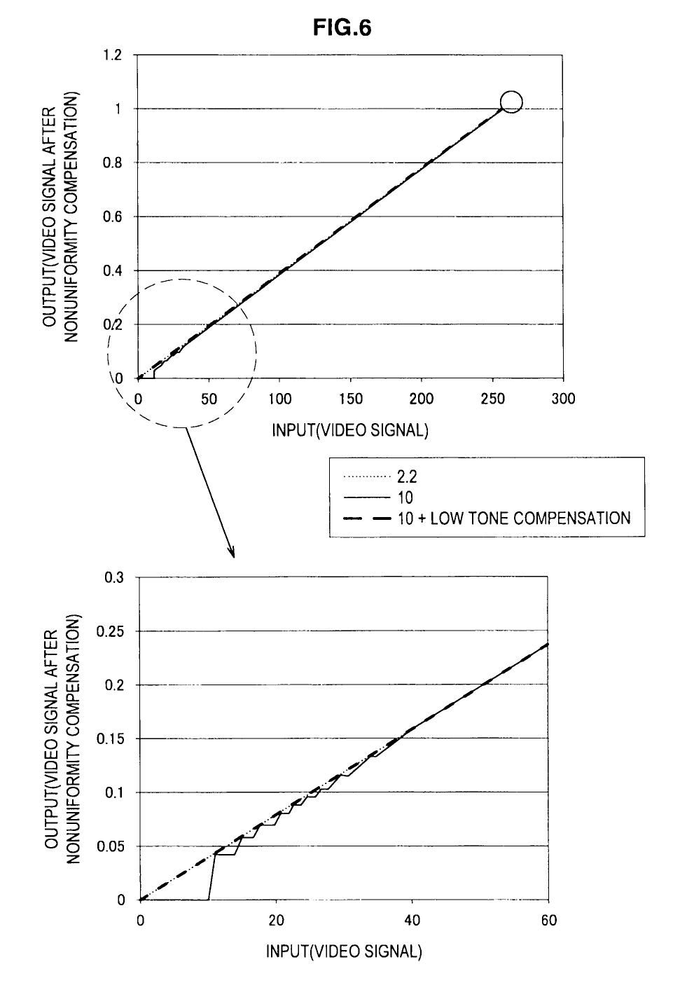

On the other hand, according to this embodiment, as shown in FIG. 6, gamma characteristic of a signal in the low tone side is considered to have characteristics almost linear, and the low tone nonuniformity compensation unit 151 has only one compensation surface in the low tone side and performs nonuniformity compensation to the field in the low tone side. In the display device 100 according to this embodiment, to the input such as the one in FIG. 6, for example, nonuniformity compensation is performed to the area where input is 40 or less by the low tone nonuniformity compensation unit 151. Thus, by performing nonuniformity compensation in the linear area and nonuniformity compensation in the low tone side outside the linear area, the display device 100 according to this embodiment can compensate nonuniformity appropriately without increasing noninformity compensating data, and compensate nonuniformity appropriately without making the bit width of the linear area higher.

### 2. Second Embodiment

In the first embodiment of the present invention mentioned above, a signal processing is performed to convert the video signal which has the gamma characteristic so as to have linear characteristics from gamma characteristics, and after performing a nonuniformity compensation process to the video signal which has linear characteristics, the video signal is converted again so that it may have the gamma characteristics, and nonuniformity compensation in the low tone side is performed to the converted video signal. Regarding the second embodiment of the present invention, explanation will be given on a case where nonuniformity compensation in the low tone side is performed before converting so that it may have a linear characteristic from the gamma characteristic.

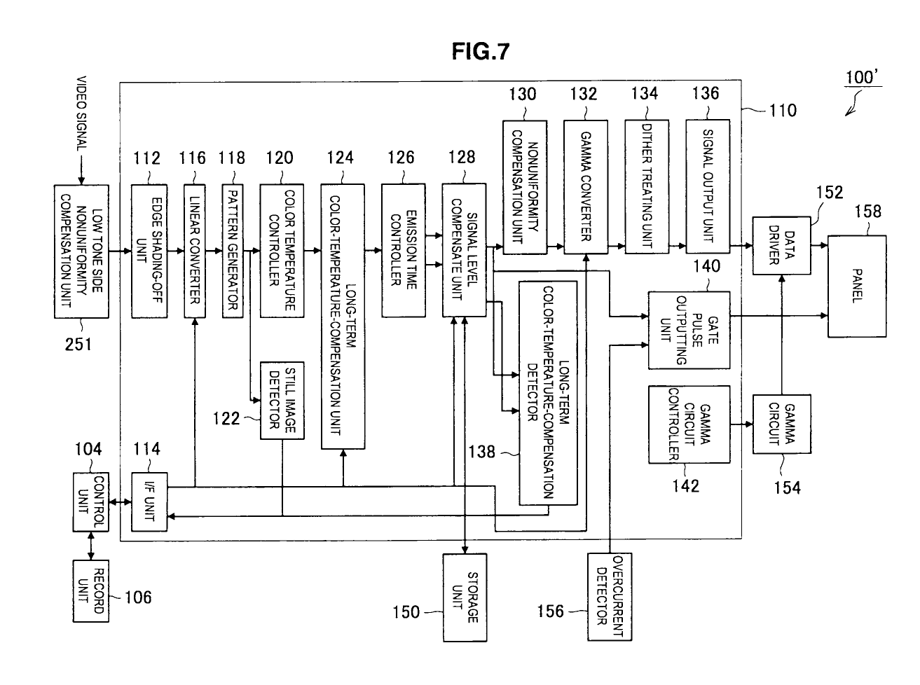

FIG. 7 is an explanatory view explaining the configuration of the display device 100′ according to the second embodiment of the present invention. Hereafter, the configuration of the display device 100′ according to the second embodiment of the present invention using FIG. 7 is explained.

Unlike the display device 100 according to the first embodiment of the present invention shown in FIG. 1, the display devices 100′ according to the second embodiment of the present invention shown in FIG. 7 has formed the low tone nonuniformity compensation unit 251 in the former of the signal-processing integrated circuit 110. The low tone nonuniformity compensation unit 251 performs nonuniformity compensation to the area in the low tone side below a predetermined input among video signals same as the low tone nonuniformity compensation unit 151 in the first embodiment of the present invention.

And the display device 100′ according to the second embodiment of the present invention sends threshold information to the linear converter 116 and the gamma converter 132 via the I/F part 114 from the control section 104 so that only the field which exceeds a predetermined input may be set as the object of signal processing at a time of signal processing in the linear converter 116, and at a time of signal processing in the gamma converter 132. The linear converter 116 receives the threshold value information from the control section 104, and converts the video signal which has the gamma characteristic into the video signal which has a linear characteristic only to the field which exceeds the threshold value. As the threshold value, explaining FIG. 6 as an example, for instance, if the input was 40 or less, it was considered as a subject of the nonuniformity compensation in the low tone nonuniformity compensation unit 251, and if the input has exceeded 40, it may be considered to be a subject of the nonuniformity compensation in the nonuniformity compensation unit 130.

And the gamma converter 132 receives the threshold value information from the control section 104, and converts the video signal which has a linear characteristic into the video signal which has the gamma characteristic only to the field which exceeds the threshold value. Between the linear converter 116 and the gamma converter 132, only the field which exceeds the threshold value sent from the control section 104 among video signals will have a linear characteristic, and the nonuniformity compensation unit 130 performs a nonuniformity compensation process to the field which has a linear characteristic.

Thus, the display device 100′ according to the second embodiment of the present invention performs nonuniformity compensation in the low tone side outside a linear field in the field where input is a predetermined threshold or less, when performing nonuniformity compensation in a linear field and nonuniformity compensation in the low tone side outside a linear field, and performs nonuniformity compensation in the linear field in the field where input exceeds a predetermined threshold. Thus, it is possible to compensate nonuniformity effectively without increasing nonuniformity compensation data by combining the nonuniformity compensation in a linear field and the nonuniformity compensation in the low tone side outside a linear field, and it is possible to compensate nonuniformity effectively without making the bit width of the linear field high, and further, it is possible to compensate nonuniformity without giving any effect on the other nonuniformity compensation each other.

### 3. Conclusion

As explained above, according to each embodiment of the present invention, comparing with the video signal which has the gamma characteristic, the number of the detecting surfaces of emission unevenness can be less by performing signal processing to the video signal which has a linear characteristic to compensate emission unevenness. Therefore, since the storage capacity of the compensation data for compensating emission unevenness can be small, this leads to the cost reduction of the display device 100. And since what is necessary is just to input the absolute value of a luminance value to the nonuniformity compensation unit 130 or the low tone nonuniformity compensation units 151 and 251, compensation in the nonuniformity compensation unit 130 can also be performed easily.

The nonuniformity compensation method according to an embodiment of the present invention mentioned above, stores a computer program created to execute the nonuniformity compensation method according to the embodiment of the present invention in a recording medium (for example, the record unit 106) inside the display device 100 in advance, and an arithmetic device (for example, the control unit 104) may read sequentially the computer program to execute it.

The preferred embodiments of the present invention have been described above with reference to the accompanying drawings, whilst the present invention is not limited to the above examples, of course. A person skilled in the art may find various alternations and modifications within the scope of the appended claims, and it should be understood that they will naturally come under the technical scope of the present invention.

### INDUSTRIAL APPLICABILITY

The present invention can be applied to a display device, a nonuniformity compensation method and a computer program, especially, it can be applied to an active-matrix type display device, a nonuniformity compensation method in the display device and a computer program, in which the scanning line which chooses a pixel with a predetermined scanning period, the data line which gives the brightness information for driving a pixel, and a pixel circuit which makes a light emitting device emit light depending on a current amount are configured to be arranged in matrix.

### REFERENCE SIGNS LIST

100 Display device
104 Control unit
106 Record unit
110 Signal-processing integrated circuit
112 Edge shading-off unit
114 I/F unit
116 Linear converter
118 Pattern generator
120 Color temperature controller
122 Still image detector
124 Long-term color-temperature-compensation unit
126 Emission time controller
128 Signal level compensate unit
130 Nonuniformity compensation unit
132 Gamma converter
134 Dither treating unit
136 Signal output part
138 Long-term color-temperature-compensation detector
140 Gate pulse outputting part
142 Gamma circuit controller
150 Storage unit
151 and 251 The low tone nonuniformity compensation unit
152 Data driver
154 Gamma circuit
156 Overcurrent detector
158 Panel
162 Level detector
164 Nonuniformity compensation information storage unit
166 and 168 Interpolation area
170 Adding machine

1. A display device comprising:
a display unit wherein a pixel having a pixel circuit for controlling current to be applied to emitting elements depending on the emitting elements that spontaneously emits depending on current volume, and a video signal, the scanning line that supplies the pixel with a selection signal which chooses a pixel to emit in a predetermined scanning period, a data line that supplies the pixel with the video signal are configured to be arranged in matrix;
a first nonuniformity compensation unit that compensates emission unevenness to the video signal with linear characteristics; and
a second nonuniformity compensation unit that compensates emission unevenness under a predetermined area to the video signal with gamma characteristics.

2. The display device according to claim 1,
wherein compensation of emission unevenness under a predetermined area is performed by the second nonuniformity compensation unit after compensation of emission unevenness by the first nonuniformity compensation unit.

3. A display device according to claim 1,
wherein compensation of emission unevenness over a predetermined area is performed by the first nonuniformity compensation unit alter compensation of emission unevenness by the second nonuniformity compensation unit under a predetermined area.

4. A display device according to claim 3, further comprising
a controller that transmits threshold specifying the predetermined area to the first nonuniformity compensation unit and the second nonuniformity compensation unit.

5. A nonuniformity compensation method comprising the steps of:
a first nonuniformity compensation that compensates emission unevenness displayed on a display unit in which a pixel having a pixel circuit for controlling current to be applied to emitting elements depending on the emitting elements that spontaneously emits depending on current volume, and a video signal, the scanning line that supplies the pixel with a selection signal which chooses a pixel to emit in a predetermined scanning period, a data line that supplies the pixel with the video signal are configured to be arranged in matrix, to the video signal with linear characteristics; and
a second nonuniformity compensation unit that compensates emission unevenness under a predetermined area to the video signal with gamma characteristics.

6. A nonuniformity compensation method according to claim 5,
wherein compensation of emission unevenness under a predetermined area is performed by the second nonuniformity compensation step after compensation of emission unevenness by the first nonuniformity compensation step.

7. A nonuniformity compensation method according to claim 5,
wherein compensation of emission unevenness over a predetermined area is performed by the first nonuniformity compensation step after compensation of emission unevenness by the second nonuniformity compensation step under a predetermined area.

8. A nonuniformity compensation method according to claim 7 comprising the step of a threshold transmitting that transmits threshold specifying the predetermined area when compensating in the first nonuniformity compensation step and the second nonuniformity compensation step.

9. A computer program for causing a computer to execute the steps of:
a first nonuniformity compensation that compensates emission unevenness displayed on a display unit in which a pixel having a pixel circuit for controlling current to be applied to emitting elements depending on the emitting elements that spontaneously emits depending on current volume, and a video signal, the scanning line that supplies the pixel with a selection signal which chooses a pixel to emit in a predetermined scanning period, a data line that supplies the pixel with the video signal are configured to be arranged in matrix, to the video signal with linear characteristics; and
a second nonuniformity compensation unit that compensates emission unevenness under a predetermined area to the video signal with gamma characteristics.
